(19) United States
(12) Patent Application Publication
(10) Pub. No.: US 2006/0181212 A1
(43) Pub. Date: Aug. 17, 2006

(54) Plasma display panel

(75) Inventors: Masahiro Sawa, Miyazaki (JP); Koji Ohira, Miyazaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Kawasaki (JP)

(21) Appl. No.: 11/346,239

(22) Filed: Feb. 3, 2006

(30) Foreign Application Priority Data
Feb. 14, 2005 (JP) 2005-036432

(51) Int. Cl. H01J 17/49

(52) U.S. Cl. 313/582

(57) ABSTRACT

A plasma display panel includes a pair of substrates, pairs of discharge electrodes, row electrodes, column electrodes, and barrier ribs. The pair of substrates have R cells, G cells and B cells which respectively generate three primary colors of red, green and blue in the discharge space to form each of pixels. The pairs of discharge electrodes are placed on one of the substrates for each of the R cell, G cell and B cell. The row electrodes, which are placed on each row of the matrix, are to supply power to each of the discharge electrodes. The column electrodes are placed on each column of the matrix on the other substrate. The barrier ribs are placed between the column electrodes in the column direction. The length in the row direction of the discharge electrodes is adjusted in accordance with the discharge timing of each cell for each of R cells, G cells and B cells.

### CROSS-REFERENCE TO RELATED APPLICATION

This application is related to Japanese Patent Application No. 2005-036432 filed on Feb. 14, 2005, on the basis of which priority is claimed under 35 USC § 119, the disclosure of this application being incorporated by reference in its entirety.

### BACKGROUND OF THE INVENTION

1. Field of the Invention

The present invention relates to a plasma display panel (hereinafter, referred to as PDP) used for a display device, such as a personal computer and a work station, a flat-type television, a display used for displaying advertisements and information, or the like, and more particularly, relates to an electrode structure of an AC surface discharge type PDP.

2. Description of the Related Art

As conventional PDPs, a three-electrode surface discharge type PDP of an AC driving type has been known. In this type of a PDP, a number of display electrodes capable of surface discharging are formed on an inner face of one of substrates (for example, a substrate on the front face side or display face side of a panel, also referred to as a front face substrate) in the horizontal direction, and a number of address electrodes for use in selecting a light-emitting cell are formed on an inner face of the other substrate (for example, a substrate on a back face side of a panel, also referred to as a back-face substrate) in a direction intersecting the display electrodes so as to form each cell (unit light-emitting area) at the intersecting portion between the display electrode and the address electrode. One pixel is constituted by three cells, that is, a red (R) cell, a green cell (G), and a blue cell (B).

The display electrodes on the front face substrate are covered with a dielectric layer. The address electrodes on the back face substrate are also covered with a dielectric layer with a barrier rib being formed between the address electrodes, and each of phosphor layers for R, G and B colors is formed between barrier ribs for areas respectively corresponding to the R cell, G cell and B cell.

The PDP is manufactured through processes in which, after the panel assembly on the front face side thus formed has been placed face to face with the panel assembly on the back face side and the periphery thereof has been sealed, a discharging gas is injected and sealed inside thereof.

In such a surface discharge type PDP, the first and second display electrodes, which form a cathode and an anode upon display-discharging between the display electrodes, that is, a main discharging, are respectively arranged on the substrate on the front face side or the back face side in parallel with each other. In the surface discharge type device, the phosphor layer for use in color displaying can be placed away from the paired display electrodes in the panel thickness direction so that it becomes possible to reduce degradation in the phosphor layer due to ion impact at the time of discharging.

The surface discharge type device is suitable for prolonging the service life in comparison with the facing discharge type device in which the first and second display electrodes are placed so as to be respectively assigned to the front face substrate and the back face substrate.

The typical electrode matrix structure of the surface discharge type PDP has “a three electrode structure” in which address electrodes for use in cell selection are arranged in a manner so as to intersect the display electrodes, and its basic form is designed so that paired display electrodes are placed on each row of the screen. The layout distance (surface discharge gap length) between the display electrodes in each row is set in a range from several tens of μm to several hundreds of μm, and an electric discharge is generated upon application of a voltage in a range from 200 to 250 volts. In contrast, the distance of electrodes on the adjacent rows (reverse slit) is set to a value that is sufficiently greater than the surface discharge gap length forming the discharge slit so as to prevent a surface discharge at that position. In this case, the reverse slit side becomes a non-light-emitting area, thereby forming a loss portion in terms of utilization factor of the screen.

Another mode of the three electrode structure is a structure in which the display electrodes are arranged with equal distances and the adjacent electrodes are allowed to function as paired electrodes to generate a surface discharge. In this structure, however, since the discharge slit and the reverse slit have the same width, with the result that it becomes difficult to operate in the case when the same driving method as that of the reverse slit side having a wide structure is adopted. For this reason, by using an interlace system in which the odd line and the even line are allowed to discharge alternately for each of the fields, a display process in which even a light emission of a discharge for one line is allowed to reach the reverse slit is carried out (See Japanese Patent Application Laid-Open No. 09-160525 and Japanese Patent Application Laid-Open No. 2000-113828).

In accordance with this method, since even the reverse slit side can form a light-emitting area, it becomes possible to improve the utilization factor of light emission, and consequently to realize a PDP with high brightness and high efficiency. However, since a complicated driving sequence is required for addressing processes that are inherently used for setting the contents of display and since no reverse slit is present to cause the display electrodes to be involved in two rows adjacent in the longitudinal direction, discharge interference tends to occur in the adjacent display cells.

With respect to the method for enhancing the utilization factor of the screen and for preventing discharge interference in the display cells adjacent in the longitudinal direction in the above-mentioned three-electrode structure, a structure is proposed in which barrier ribs are formed on the back face substrate in parallel with the row direction (lateral direction) in a manner so as to be placed on the display electrodes of the front face substrate with equal intervals so that the continuous display electrodes are superposed on the power supplying conductive film (bus electrodes) over the entire length in the row direction. This structure has a unit light-emitting area (one cell) that forms a space with its four sides closed by surrounding barrier ribs, and is referred to as a box cell structure (See Japanese Patent Application Laid-Open No. 2003-5699).

In this box cell structure, the phosphor area relating to light emission per one cell increases, resulting in an increase in the light emission efficiency by about 1.2 times. The reason for this is explained as follows: in the case when the lateral barrier ribs have the box cell structure on the bus electrodes, no light blocking is caused on the light-emitting area by the bus electrodes so that it becomes possible to effectively utilize the phosphor light emission. However, this structure is effective on the premise that the width of the barrier ribs in the lateral direction of the box cell structure is greater than the bus electrode width and that the positioning between the bus electrodes and the lateral barrier ribs (positioning between the front face substrate and the back face substrate) is carried out with considerably high precision. In the actual structure, by taking into consideration deviations in this positioning process, the width of the barrier ribs is made greater than the width of the bus electrodes by several tens μm.

In the box cell structure, a transfer of a charge in the longitudinal direction is physically blocked by the barrier ribs in the lateral direction so that discharge interference with the adjacent cell in the longitudinal direction can be blocked. The above-mentioned Japanese Patent Application Laid-Open No. 2003-5699 describes a driving sequence that achieves a display of a progressive format by taking an advantage that discharge interference is blocked in the column direction. In this driving sequence, the rows (display line) are divided into two groups in accordance with a specific rule, and the addressing is carried out on each of the groups, with a reset step including a charge adjustment being interposed between an addressing process to one of the groups and an addressing process of the other group.

FIGS. 11 and 12 show a typical structure of this type. FIG. 12 is an enlarged view of FIG. 11. This electrode structure is referred to as a ladder electrode structure since ITO electrodes (transparent electrodes) that are display electrodes are laterally connected in a ladder form.

There is a difference in the discharge voltage (surface discharge voltage and facing discharge voltage) in each of cells with respective R, G and B colors, and with respect to the size relationship of the voltages, in particular, the R cell has a lower voltage. In the case of a PDP having a ladder electrode structure shown in FIGS. 11 and 12, the same electrode structure is used for the respective colors although the discharge starting voltage is different in each of the cells with respective R, G and B colors, with the result that when the same voltage is applied to the respective cells of R, G and B, a difference occurs in strength of the discharge and timing of the discharge start to sometimes cause irregularities and a malfunction upon emission of light.

More specifically, the discharge timing of the R cell having a low discharge starting voltage has an earlier timing to cause a flickering phenomenon due to a failure (strong electric discharge) in the reset and redness and color nonuniformity in white lighting at the time of the display electric discharge. This problem is particularly remarkable in a large-size panel having a large difference in the discharge timing due to a large voltage drop as well as in a partition structure of a closed system such as a box cell structure. Moreover, during an address discharging process for facing discharge that determines the display state, a large voltage difference is caused to the G cell and B cell, resulting in a failure to maintain a driving margin in some cases. Since the ladder shape is used, a lateral coupling phenomenon (interference of discharge in the row direction) also tends to occur.

The present invention has been devised to solve the above-mentioned problems, and its objective is to equalize the discharge starting voltages of the cells of the respective colors by changing the ladder electrode structure in a PDP depending on the R cell, G cell and G cell so that the discharge timing is leveled, the failure in discharging is corrected and the occurrence of a lateral coupling phenomenon or the like is reduced; thus, it becomes possible to improve the display quality.

Here, with respect to the method for changing the electrode shapes depending on the respective colors, a method has been known in which the electrode areas are changed, with electrodes being connected in the lateral direction in the cell (See Japanese Patent Application Laid-Open No. 2000-123748). In this method, however, its objective is to adjust the white color temperature by changing the electrode areas depending on the cells of the respective colors, and the reducing effects on a difference in the discharge timing of each of the colors, as well as in the facing discharge voltage, are rather small.

Moreover, another method has been known (See Japanese Patent Application Laid-Open No. 2001-160361 and Japanese Patent Application Laid-Open No. 2001-266750) in which the display electrode is prepared as an isolated electrode that is not connected laterally in the cell so that the electrode areas are made different depending on the respective colors. In this method, however, since strict limitations are required on the surface discharge electrode dimension of the respective colors, the sensitivity to deviations in production becomes high, failing to provide a practical method.

### SUMMARY OF THE INVENTION

The present invention provides a plasma display panel comprising: one substrate and the other substrate that face toward each other with a discharge space therebetween, having R cells, G cells and B cells which respectively generate three primary colors of red, green and blue in the discharge space to form each of pixels, the R cells, G cells and B cells being arranged in a matrix format; pairs of discharge electrodes placed on one of the substrates for each of the R cell, G cell and B cell with a constant surface discharge gap; row electrodes for supplying power to each of the discharge electrodes, the row electrodes being placed on each row of the matrix; column electrodes placed on each column of the matrix on the other substrate; barrier ribs placed between the column electrodes in the column direction, wherein the length in the row direction of the discharge electrodes is adjusted in accordance with the discharge timing of each cell for each of R cells, G cells and B cells.

In accordance with the present invention, since the discharge timing difference among the respective colors can be reduced, a reduction in color irregularities is achieved. In particular, the present invention is effectively applied to a large-size panel which has a large voltage drop with the result that color irregularities and red irregularities tend to occur remarkably due to the discharge timing difference as well as to a closed rib structure. Moreover, since it is possible to reduce a failure in discharging upon resetting by the reduction in the voltage difference in the respective colors, a flickering phenomenon or the like on a specific gradation can also be reduced. Moreover, since the reduction in current is also expected because of the reduction in the electrode area, it is possible to improve the efficiency, to reduce streaking and also to reduce the lateral coupling phenomenon. Consequently, it becomes possible to manufacture a PDP with high quality and high performance.

### BRIEF DESCRIPTION OF THE DRAWINGS

FIG. 1 is a partially exploded perspective view that shows a structure of a PDP in accordance with Embodiment 1 of the present invention;

FIG. 2 is an explanatory view that shows the PDP on a plan view;

FIG. 3 is an enlarged view of FIG. 2;

FIG. 4 is an explanatory view that shows a positional relationship between an electrode edge and a first barrier rib;

FIG. 5 is an explanatory view that shows a relationship between the positional relationship between the electrode edge and the first barrier rib and a discharge voltage;

FIG. 6 is an explanatory view that shows the structure in accordance with Embodiment 2 of the present invention;

FIG. 7 is an explanatory view that shows the structure in accordance with Embodiment 3 of the present invention;

FIG. 8 is an explanatory view that shows the structure in accordance with Embodiment 4 of the present invention;

FIG. 9 is an explanatory view that shows the structure in accordance with Embodiment 5 of the present invention;

FIG. 10 is an explanatory view that shows the structure in accordance with Embodiment 6 of the present invention;

FIG. 11 is an explanatory view that shows a conventional ladder electrode structure; and

FIG. 12 is an enlarged view of FIG. 11.

### DESCRIPTION OF THE PREFERRED EMBODIMENTS

Examples of one and the other of substrates of the present invention include substrates made from glass, quartz, ceramics, or the like, and the above mentioned substrates having formed thereon desired components, such as an electrode, an insulating film, a dielectric layer, and a protective film.

R cells, G cells and B cells are arranged in a matrix format in a discharging space between the one and the other of the substrates so that the respective cells emit three primary colors of red, green, and blue to form each pixel, and any of substrates of this type may be used. These cells may adopt those formed by known materials using known methods in the related field.

Paired discharge electrodes may be placed on one of the substrates (for example, a front face substrate) with a constant surface discharge gap for each of the R cell, G cell and B cell. Further, row electrodes may be placed for each row of the matrix, and allowed to supply power to the discharge electrodes. These electrodes may be formed by using various known materials and methods in the corresponding field. Examples of materials used for the discharge electrodes include transparent conductive materials such as ITO or SnO₂. Examples of materials used for the row electrodes include metal conductive materials, such as Ag, Au, Al, Cu or Cr. With respect to the forming method of the electrodes, various methods conventionally known in the corresponding field may be used. For example, the electrodes may be formed by using a thick film forming technique, such as a printing method, or a thin film forming technique, such as a physical deposition method or a chemical deposition method. With respect to the thick film forming technique, a screen printing method or the like may be used. With respect to the physical deposition method among the thin-film forming techniques, a vapor deposition method, a sputtering method and the like may be used. With respect to the chemical deposition method, a method, such as a thermal CVD method, an optical CVD method, or a plasma CVD method, may be adopted.

Each discharge electrode, arranged on one of substrates forming a front face substrate, is constituted by a first transparent electrode used for surface discharging, and connected with each other through adjacent cells in the row direction, and a second transparent electrode that connects the first transparent electrode to the row electrodes, and it is preferable that the distance between the electrode edge, which faces the barrier rib of the first transparent electrode in parallel with each other, and the barrier rib is set to a gap that can maintain an expansion of the surface discharge.

Moreover, the discharge electrode placed on each of the cells preferably has the same surface discharging gap length with respect to each of the cells.

With respect to the G cell and B cell, the surface discharging gap length in the row direction is preferably made longer than that of the R cell.

It is preferable that, in the first transparent electrode, cut-out sections are formed on the surface-discharging gap side between the R cell and G cell, as well as between the B cell and R cell, and a cut-out section is formed on the side opposite to the surface-discharging gap between the G cell and B cell, with the length of the R cell in the row direction of the surface-discharging gap being made shorter than that of the G cell and B cell.

The first transparent electrodes preferably have a linear symmetric shape with the surface discharge gaps being sandwiched on the cells having the respective colors. Moreover, the area of the first transparent electrode is preferably made to have the same area with respect to all the R cell, G cell and B cell.

The following description will discuss the present invention in detail with reference to embodiments shown in the drawings. However, the present invention is not intended to be limited thereby, and various changes and modifications can be made therein without departing from the spirit and scope thereof.

### Embodiment 1

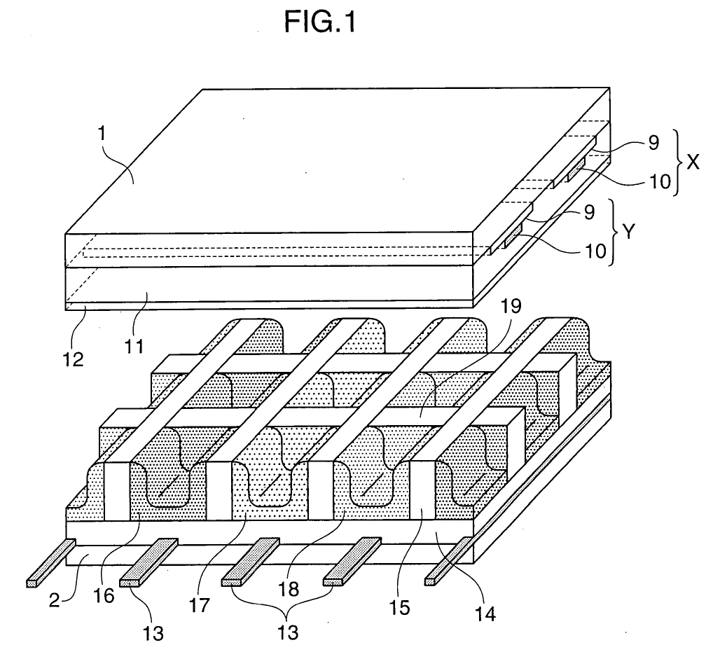

FIG. 1 is a partially exploded perspective view that shows a structure of a PDP in accordance with Embodiment 1 of the present invention. This PDP is a three-electrode surface-discharge type PDP of an AC driving system for use in color display.

Display electrodes X and display electrodes Y are formed on the front face side of a substrate 1 virtually in parallel with each other. Each of the display electrodes X and Y is constituted of transparent electrodes 9 used for generating a surface discharge and respectively made of ITO, and a metal bus electrode 10 having a three-layer structure of Cr/Cu/Cr that forms a power supply line. The display electrode Y is used as a scanning electrode. Here, a dielectric layer 11 is formed in a manner so as to cover these surface electrodes X and Y, with a protective film 12 formed on the surface of the dielectric layer 11. Although only one pair of the display electrode X and the display electrode Y is shown in the Figure, a plurality of them are installed in accordance with the number of cells in the column direction, in the actual structure.

The thickness of the substrate 1 on the front face side is about 2 to 3 mm, the thickness of the dielectric layer 11 is set to several μm when it is a film formed by the CVC method, and is also set to several tens of μm when it is a film formed by the printing method, and the thickness of the protective film 12 is about 1 μm. The substrate on which a group of electrodes, the dielectric layer and the protective layer are formed is referred to as a panel assembly on the front face side, or sometimes referred to simply as a substrate on the front face side.

The substrate 2 on the back face side is the same as that of a typical known surface discharge type PDP. Address electrodes 13 are formed on the substrate 2 on the back face side in parallel with each other, and these are covered with a dielectric layer 14. A barrier rib 15 extending in the column direction is formed between the address electrodes 13 and 13, and phosphor layers 16, 17 and 18 of R (red), G (green) and B (blue) colors are successively formed on the side face of the barrier rib 15 and the dielectric layer 14.

The thickness of the substrate 2 on the back face side is about 2 to 3 mm, the thickness of the dielectric layer 14 is set to several tens of μm, and the height of the barrier rib 15 is in a range of 100 to 200 μm. The substrate on which a group of electrodes, the dielectric layer, the barrier rib and the phosphor layer are formed is referred to as a panel assembly on the back face side, or sometimes referred to simply as a substrate on the back face side.

The barrier ribs 19, placed in a direction orthogonal to the barrier ribs 15, that is, in the row direction, are formed on the substrate 2 on the back face side regularly with fixed intervals, and a closed discharging space (cell opening section), formed by the barrier ribs 15 in the column direction (hereinafter, referred to as the first barrier rib) and the barrier ribs 19 in the row direction (hereinafter, referred to as the second barrier rib), forms a unit light-emitting area. This structure is a so-called “box cell structure”.

The second barrier rib 19 and the bus electrode 10 of the substrate 1 on the front face side are placed at positions to be superposed on each other in the plan view. This structure is a so-called “common-bus electrode structure”. Therefore, the pitch of the bus electrode 10 of the substrate 1 on the front face side and the pitch of the second barrier rib 19 on the substrate 2 on the back face side are set to the same value.

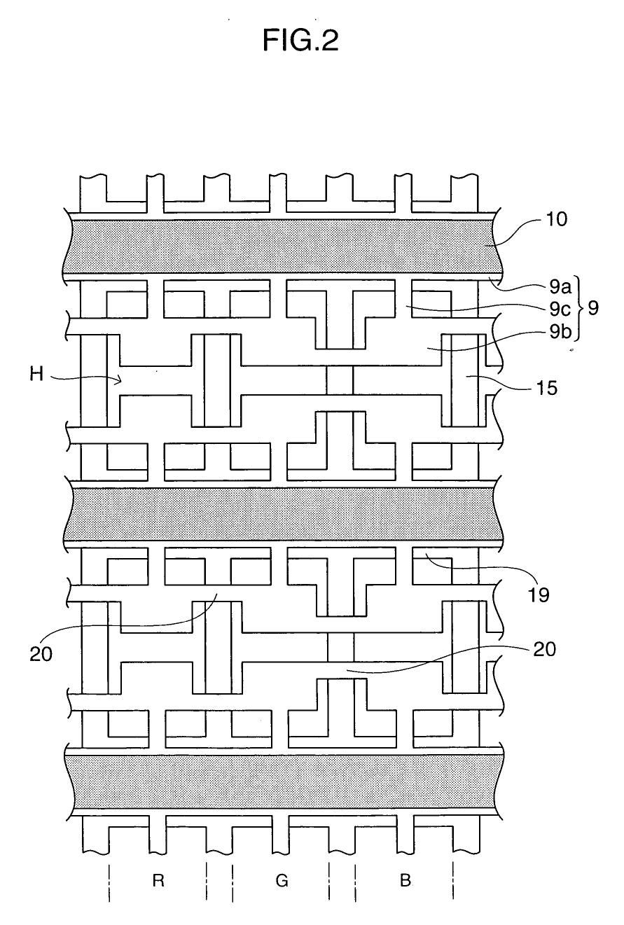

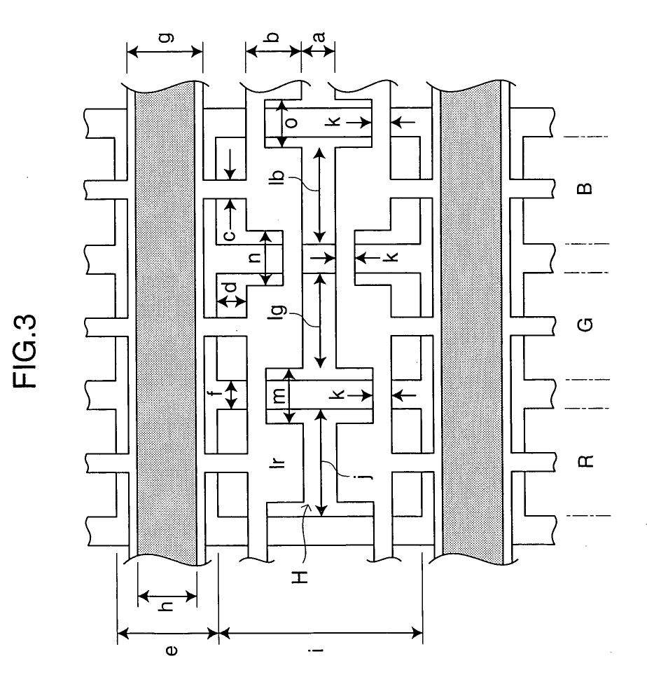

FIG. 2 is an explanatory view that shows the state of the PDP in the plan view, and FIG. 3 is an enlarged view of FIG. 2.

As described above, the display electrodes X and Y are constituted by the transparent electrodes 9 and the bus electrode 10. The transparent electrode 9, which is designed to a ladder shape, is constituted of a base portion 9a placed along the second barrier rib 19, a ladder portion 9b that is placed with a constant distance from the base portion 9a in parallel therewith and a neck portion 9c that connects the base portion 9a to the ladder portion 9b. The ladder portion 9b is also referred to as a surface discharge electrode.

With respect to the ladder portion 9b, cut-out sections are formed between the R cell and G cell as well as between the B cell and R cell on the surface discharge gap H side, and a cut-out section is formed between the G cell and B cell on the side opposite to the surface discharge gap H side.

The bus electrode 10 is formed on the base portion 9a of the transparent electrode.

The discharge voltage and light-emitting characteristics vary greatly depending on the positional relationship between the electrode and the barrier rib.

With respect to specific dimensions, the difference between the width e of the second barrier rib 19 and the width h of the bus electrode 10 is indicated by e−h≦20 μm, and the distance d between the second barrier rib 19 and the ladder portion 9b of the transparent electrode is indicated by 30 μm≦d≦80 μm. These limitations are defined by taking into consideration the positioning precision in the current production, and the present invention is also based upon these limitations.

Moreover, although not particularly limited, the other dimensions are set as follows. The surface discharge gap length a is 100 μm, the width b of the ladder portion 9b of the transparent electrode is 210 μm, the width c of the neck portion 9c is 50 μm, the width f of the first barrier rib 15 is 60 μm, the width g of the base portion 9a of the transparent electrode is h+20 μm, the distance i of the second barrier ribs is 640 μm, the distance j of the first barrier ribs is 240 μm, and the width k of the electrode connecting portion is 50 μm. These values vary depending on the panel size, the number of pixels or the target values of characteristics.

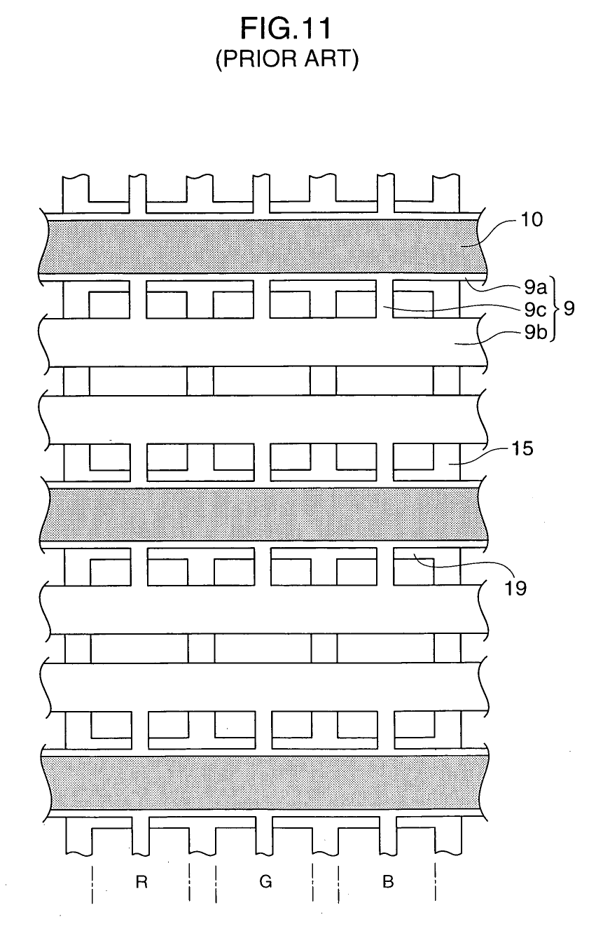

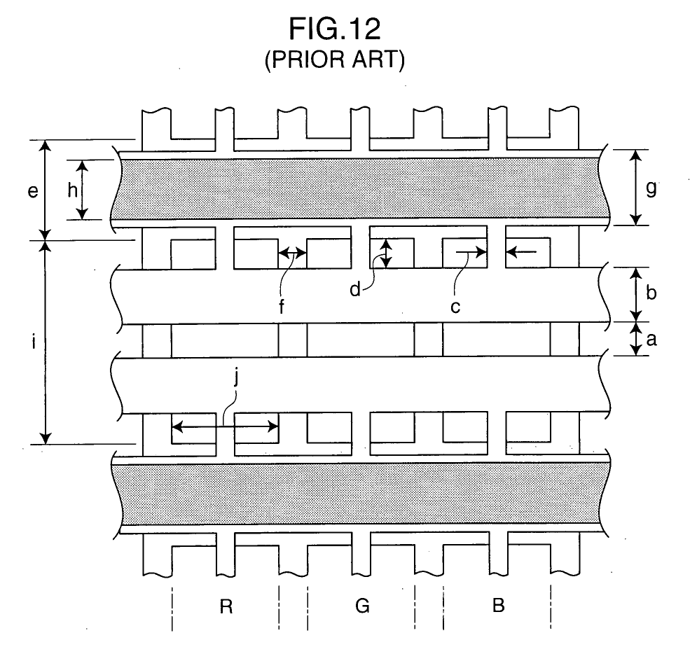

When these values are compared with the dimensions of the electrode structure shown in FIGS. 11 and 12, the surface discharge gap length a, the width b of the ladder portion 9b of the transparent electrode, the width c of the neck portion 9c, the distance d between the second barrier rib 19 and the ladder portion 9b of the transparent electrode, the width e of the second barrier rib 19, the width f of the first barrier rib 15, the width g of the base portion 9a of the transparent electrode, the distance h of the bus electrode 10, the distance i of the second barrier ribs and the distance j of the first barrier ribs are the same.

In order to reduce a timing difference in discharges of the respective colors, the shape of the ladder-type display electrodes is changed depending on the respective colors. More specifically, a lateral connecting portion 20 of the display electrode is placed on the side opposite to the surface discharge gap with respect to the R cell having a low voltage, while this is placed on the surface discharge gap side with respect to the B cell and G cell having a high voltage, so that the lateral lengths of the gap portion are changed depending on the respective colors; thus, it becomes possible to reduce a voltage difference in surface discharges for the respective colors.

The main characteristic of the present invention is that although the surface discharge gap length and the electrode area of the cell opening section are set to the same values for the cells of the respective colors, the electrode shapes in a plan view are made different among the cells of the respective colors. The cell opening section refers to a rectangular discharge space surrounded by the first barrier ribs 15 and the second barrier ribs 19.

Moreover, with respect to the R cell, the length of the surface discharge gap in the row direction is designed to be shorter than that of the G cell and the B cell. More specifically, the following relationship holds in FIG. 3.
lr<lg≦lb<j (formula 1)
k<b (formula 2)

Here, lr, lg and lb are lengths in the row direction of the respective surface discharge gaps of the R cell, G cell and B cell.

Since the above-mentioned relationship expressed by the formula 1 gives an influence to the discharge starting voltage, the discharge starting voltage of the R cell inherently having a low voltage is made closer to the discharge starting voltage of the G cell and the B cell. Moreover, since the discharge starting voltage of the B cell is normally similar to or slightly higher than that of the G cell, the relationship expressed by the formula 1 is satisfied. In addition, with the state in which the electrodes are connected in the row direction being maintained, the electrode area is reduced in comparison with the electrode structures shown in FIGS. 11 and 12 so that the lengths in the row direction of the surface discharge gaps are made different; thus, the relationship expressed by the formula 2 is satisfied.

Between the G cell and B cell, the connecting portion 20 of the electrode is formed on the surface discharge gap side, and between the R cell and G cell as well as between the B cell and R cell, the connecting portion 20 of the electrodes is formed on the side opposite to the surface discharge gap.

Moreover, the positional relationship between the length in the row direction of the surface discharge gap and the first barrier rib is set in the following manner:
20 μm≦(j−lr)/2 (formula 3)
20 μm≦j−lg (formula 4)
20 μm≦j−lb (formula 5)

As described above, j represents the distance between the first barrier ribs. Moreover, the formulas 3 to 5 indicate that the extension edge portion in the electrode longitudinal direction (hereinafter, also referred to simply as “electrode edge”), which corresponds to the surface discharge electrode facing the first barrier rib in parallel therewith within each cell, requires a distance of 20 μm or more to the first barrier rib. This also indicates that the following relationships are required.
20 μm≦(m−f)/2 (formula 6)
20 μm≦(n−f)/2 (formula 7)
20 μm≦(o−f)/2 (formula 8)

Here, m is a distance between cut-out sections respectively in the R cell and G cell, n is a distance between cut-out sections respectively in the G cell and B cell, and o is a distance between cut-out sections respectively in the B cell and R cell. As described above, f represents the width of the first barrier rib.

In the case when the relationships indicated by the formulas 3 to 8 are not satisfied, that is, in the case when the distance between the electrode edge and the first barrier rib becomes 20 μm or less, it is not possible to maintain the expansion of the surface discharge. In other words, the discharge and the effective area of the subsequent light-emission become smaller, causing serious degradation in the reduction of the voltage difference among the respective colors and the balance of light-emitting intensities among the respective colors, which are initial objectives of the invention.

Here, the distance between the electrode edge within the R cell and the first barrier rib is preferably set to the same value in the right and left sides.

Here, the size relationship of m, n and o is determined as follows:
m=n=o (formula 9)

Based upon the relationship indicated by the formula 9, the surface-discharge electrode areas in the cell opening sections that do not intersect the first barrier rib are set to the same value among the respective colors, with only the length in the row direction of the surface discharge gap in the R cell being made shorter; thus, it becomes possible to reduce voltage differences among the R cell, G cell and B cell.

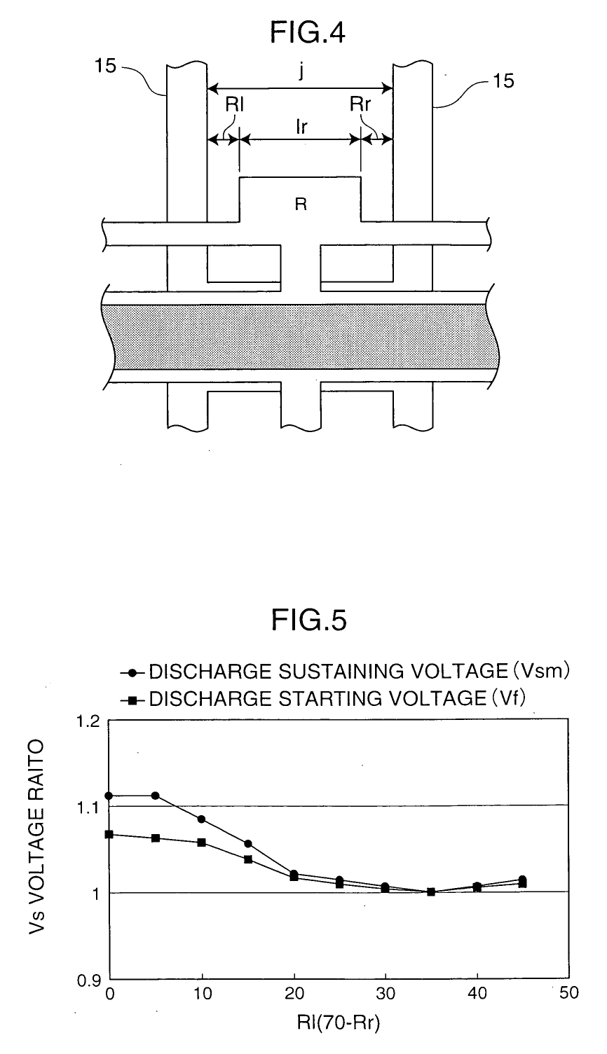

FIG. 4 is an explanatory drawing that indicates the positional relationship between the electrode edge and the first barrier rib, and FIG. 5 is a graph that shows the positional relationship between the electrode edge in relation to the discharge voltage.

The above-mentioned description has discussed that, when the distance between the electrode edge and the first barrier rib becomes 20 μm or less, the discharge and the effective area of the subsequent light emission become smaller to cause serious degradation in the balance of light-emitting intensities among the respective colors; and the following description will discuss this point by exemplifying the R cell.

As shown in FIG. 4, suppose that the distance between the first barrier ribs 15 is j and that the length in the row direction of the surface discharge gap is lr. Moreover, suppose that the distance between the left-side electrode edge of the R cell and the first barrier rib 15 is Rl and that the right-side electrode edge of the R cell and the first barrier rib 15 is Rr.

In the case when distance j between the first barrier ribs=240 μm and surface discharge gap length lr=170 μm, in the event of a lateral offset in the positioning process between the front-face side substrate and the back-face side substrate, the change in the surface discharge voltage is indicated by a graph shown in FIG. 5.

In the graph, Rl (μm) is indicated on the axis of abscissas and Vs voltage ratio is indicated on the axis of ordinates. In other words, supposing that the voltage is “1” when Rl is 35 μm, the axis of ordinates indicates how the voltage fluctuates in response to a change in Rl as a ratio, which is given as Vs voltage ratio. Since the axis of abscissas Rl indicates j=240 μm when lr=170 μm, Rl=(j−lr)−Rr=70−Rr is satisfied.

This graph shows the discharge sustaining voltage Vsm and the discharge starting voltage Vf. The discharge starting voltage Vf is a voltage, which is generally referred to as reset discharge, and is applied upon generating an electric discharge used for erasing a wall charge formed on the surface discharge electrode. In other words, this is a discharge generating voltage in a state in which no wall charge has been formed on the surface discharge electrode. The discharge sustaining voltage Vsm is a voltage, which is generally referred to as display discharge or sustain discharge, and is applied upon generating a discharge by utilizing a wall charge formed on the surface discharge electrode, and this corresponds to a discharge generating voltage in a state in which a wall charge is formed on the surface discharge electrode.

As clearly indicated by this graph, with respect to variations in Rl and Rr, that is, lateral deviations occurring at the time of positioning the substrate on the front face side and the substrate on the back face side, when either one of Rl and Rr becomes 20 μm or less, an increase in the discharge voltage becomes extremely high. Moreover, the lateral deviations give greater influences to the discharge sustaining voltage Vsm. From these points of view, the distance between the electrode edge and the first barrier rib is preferably set to 20 μm or less.

### Embodiment 2

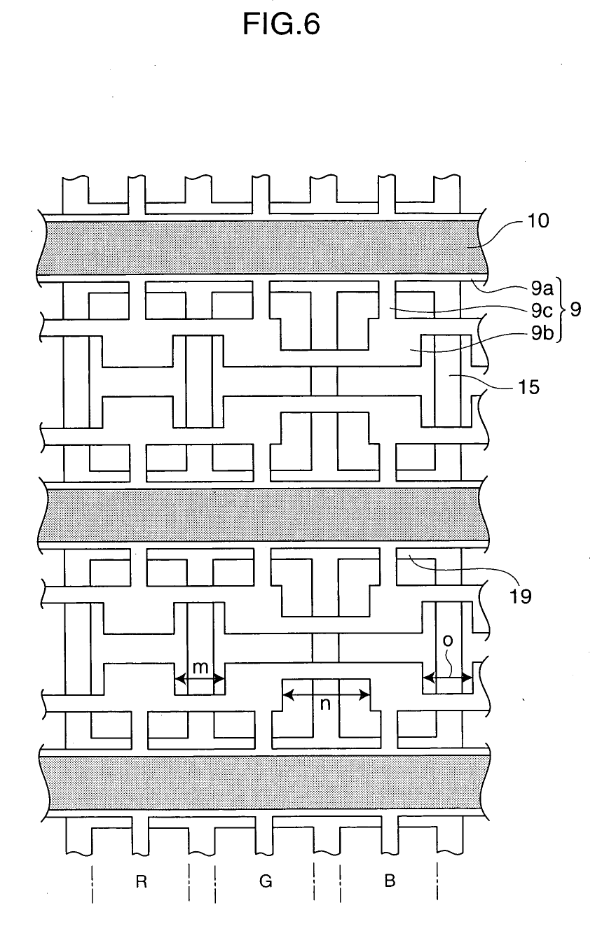

FIG. 6 is an explanatory drawing that shows the structure of Embodiment 2 of the present invention.

Several Embodiments are proposed by changing the relationship among sizes of m, n and o.

In FIG. 6, the following relationship is satisfied.
m=o<n (formula 10)

In accordance with the relationship by the above-mentioned formula 10, the surface discharge electrode areas at cell opening sections that do not intersect the first barrier rib are made constant so that it also becomes possible to provide a structure in which only the length in the row direction of the surface discharge gap in the R cell is shorter, and consequently to shorten the voltage difference among the R cell, G cell and B cell.

### Embodiment 3

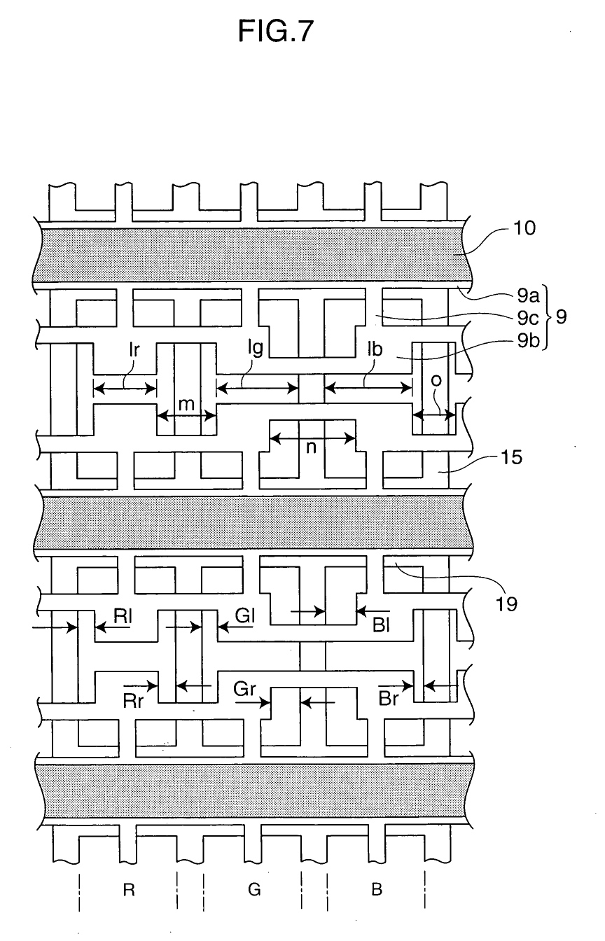

FIG. 7 is an explanatory drawing that shows the structure of Embodiment 3 of the present invention.

In the present embodiment, the following relationship is satisfied.
n>m>o (formula 11)

As described above, m represents the distance between the cut-out sections in the R cell and the G cell, n represents the distance between the cut-out sections in the G cell and the B cell, and o represents the distance between the cut-out sections in the B cell and the R cell.

In this electrode structure, by setting the dimensions of n, m and o as well as the distance between the electrode edge and the first barrier rib to the following dimensions, the lengths in the row direction of the surface discharge gap are all made different among the R cell, G cell and B cell.

The settings are respectively made as follows: n=130 μm, m=120 μm, o=110 μm, Rl=30 μm, Rr=30 μm, Gl=30 μm, Gr=30 μm, Bl=40 μm and Br=20 μm, where the factors represent as follows, respectively: Rl is a distance between the left-side electrode edge of the R cell and the first barrier rib, Rr is distance between the right-side electrode edge of the R cell and the first barrier rib, Gl is distance between the left-side electrode edge of the G cell and the first barrier rib, Gr is distance between the right-side electrode edge of the G cell and the first barrier rib, B 1 is distance between the left-side electrode edge of the B cell and the first barrier rib, and Br is distance between the right-side electrode edge of the B cell and the first barrier rib.

In this structure, the following relationship is satisfied:
lr<lg<lb<j (formula 12)

As described above, lr, lg and lb indicate the lengths in the row direction of the surface discharge gaps of the R cell, G cell and B cell respectively, and j indicates the distance between the first barrier ribs.

With this structure, the areas of the surface discharge electrodes of the respective colors can be kept constant.

### Embodiment 4

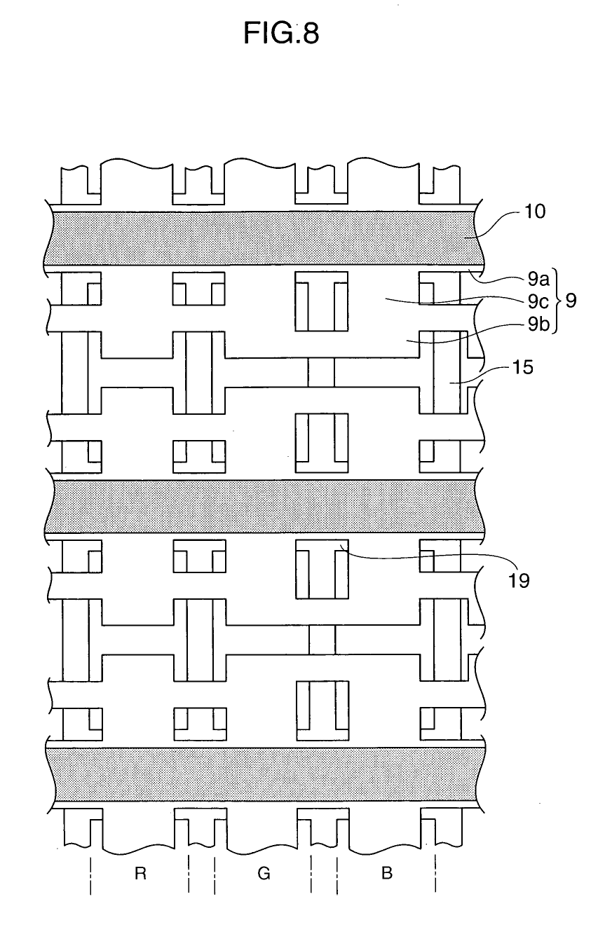

FIG. 8 is an explanatory drawing that shows the structure of Embodiment 4 of the present invention.

The present embodiment, which is a modified example of the shape of the transparent electrode 9, has a structure in which the neck portion 9c of the transparent electrode 9 is not narrowed. The sizes of the other portions are set to the same sizes as those of the Embodiments 1 to 3.

### Embodiment 5

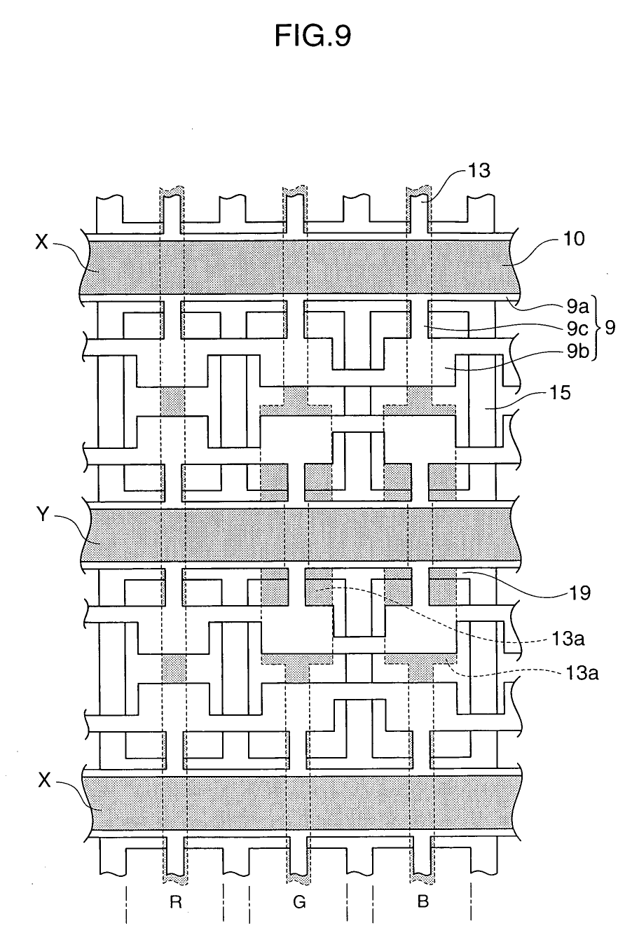

FIG. 9 is an explanatory drawing that shows the structure of Embodiment 5 of the present invention.

Voltage difference in the discharge voltage of the respective color cells is present not only on a surface electric discharge between display electrodes but also on a facing electric discharge between the display electrode Y and the address electrode 13 used as scanning electrodes, and with respect to the facing electric discharge, the facing discharge starting voltage in the R cell is considerably lower than that of the G cell and B cell. For this reason, this voltage difference tends to cause adverse effects on the voltage margin at the time of an addressing process by the facing electric discharge.

Therefore, in the present embodiment, the address electrode 13 of the substrate 2 on the back face side, which is located at an intersecting position so as to face display electrodes (Y electrodes) used as scanning electrodes of the substrate 1 on the front face side, is provided with a pad portion 13a, and by eliminating this pad portion 13a only from the R cell, the voltage difference in the facing electric discharge at the time of the addressing process can be reduced.

Although the present embodiment is combined with Embodiment 1, the present embodiment may be combined with Embodiment 2 as well. In this manner, in both of the surface electric discharge and facing electric discharge, the voltage difference in the respective cells can be reduced, and the entire driving margin can be adjusted.

### Embodiment 6

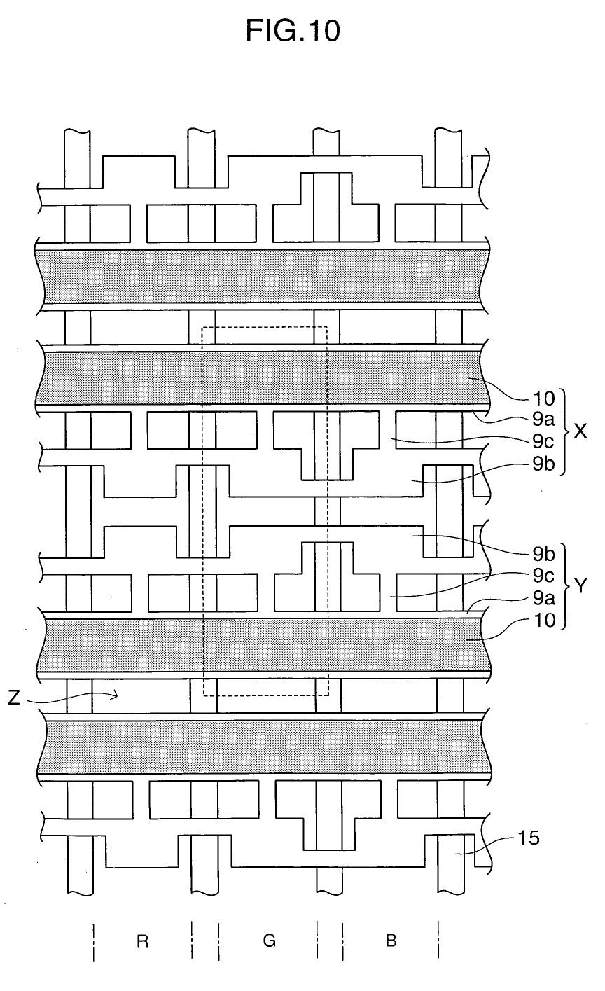

FIG. 10 is an explanatory drawing that shows the structure of Embodiment 6 of the present invention.

In the above-mentioned variations in the electrode shape, a so-called stripe barrier rib structure without barrier ribs in the row direction, or a PDP having an electrode structure in which a pair of display electrodes is placed with a gap that prevents generation of a discharge between the electrodes may also achieve the same effects. The present embodiment describes a typical structure of such barrier ribs and electrodes. In this Figure, one area of the G cell is indicated by a dot line. In this structure, there are no barrier ribs in the raw direction. Moreover, display electrodes X and Y have a paired structure, and a reverse slit Z that generates no electric discharge is placed between the display electrodes X, Y and display electrodes X, Y.

As described above, in the present invention, the shapes of the ladder-type display electrodes are changed depending on the respective colors so as to reduce difference in discharging timing of the respective colors. More specifically, the connecting portion in the lateral direction of the display electrodes is placed on the side opposite to the surface discharge gap with respect to the R cell having a low voltage, while this is placed on the surface discharge gap side with respect to the B cell and G cell having a high voltage, so that the lengths of the surface discharge gap are changed depending on the respective colors; thus, it is possible to reduce a voltage difference in surface discharges for the respective colors. In this case, since the electrode areas are made identical with respect to each of the colors, strict limitations are not required for the electrode dimensions of the respective cells, and these structures are not sensitive to deviations upon production.

Moreover, in the present invention, since the area of the connecting portion of the ladder-type display electrodes is kept comparatively smaller, it is possible to reduce the phenomenon of a lateral coupling of electric discharging. Since the electrode area is made smaller, it becomes possible to reduce an electric current, and consequently to improve the efficiency and reduce the streaking. Furthermore, by adjusting the length of the surface discharge gap, the line-to-line capacitance can be reduced so that it becomes possible to reduce the streaking and the reactive power. Since the surface discharge electrode areas are maintained the same for the respective colors, extreme variations and the like in luminance balance do not occur among the respective colors.

In addition, in the conventional arrangement, with respect to the address electrode placed on the substrate on the back face side, the width of the address electrode is widened with a size slightly smaller than the cell lateral space at a position that faces and intersects the Y electrodes (scanning electrodes) so that the facing electric discharge is easily generated at the time of an addressing process; however, in the present invention, by providing a structure in which the pad portion is not installed on the address electrode in the R cell, the voltage difference in the facing electric discharge is also reduced in combination with the improvement of the ladder-type display electrode.

What is claimed is:

1. A plasma display panel comprising:
one substrate and the other substrate that face toward each other with a discharge space therebetween, having R cells, G cells and B cells which respectively generate three primary colors of red, green and blue in the discharge space to form each of pixels, the R cells, G cells and B cells being arranged in a matrix format;
pairs of discharge electrodes placed on one of the substrates for each of the R cell, G cell and B cell with a constant surface discharge gap;
row electrodes for supplying power to each of the discharge electrodes, the row electrodes being placed on each row of the matrix;
column electrodes placed on each column of the matrix on the other substrate;
barrier ribs placed between the column electrodes in the column direction,
wherein the length in the row direction of the discharge electrodes is adjusted in accordance with the discharge timing of each cell for each of R cells, G cells and B cells.

2. The plasma display panel according to claim 1, wherein
each of the discharge electrodes placed on the one of the substrates forming a front substrate is formed by surface discharging first transparent electrodes with adjacent cells being connected with each other in the row direction and second transparent electrodes that connect the first transparent electrode and the row electrodes, with the distance between the barrier rib of the first transparent electrode and each of the electrode edges that faces the barrier rib in parallel with each other being set to a gap that is capable of maintaining an expansion of surface discharging.

3. The plasma display panel according to claim 1, wherein the discharge electrodes, placed on each of the cells, have the same surface discharge gap length on each of the cells.

4. The plasma display panel according to claim 1, wherein the G cell and the B cell have a length in the row direction of the surface discharge gap that is longer than that of the R cell.

5. The plasma display panel according to claim 2, wherein the first transparent electrode has a cut-out portion on the surface discharge gap side between the R cell and G cell as well as between the B cell and R cell, and a cut-out portion is formed on the side opposing to the surface discharge gap between the G cell and the B cell, with the R cell having a length in the row direction of the surface discharge gap that is shorter than that of each of the G cell and B cell.

6. The plasma display panel according to claim 2, wherein the first transparent electrode has a linear symmetric shape with the surface discharge gap being sandwiched on the cells having the respective colors, and the area of the first transparent electrode is the same with respect to all the R cell, G cell and B cell.
